(19) United States
(12) Patent Application Publication
(10) Pub. No.: US 2016/0045064 A1
(43) Pub. Date: Feb. 18, 2016

(54) PORTABLE BEVERAGE CONTAINER

(71) Applicant: Jesus LOPEZ, Los Angeles, CA (US)

(72) Inventor: Jesus LOPEZ, Los Angeles, CA (US)

(21) Appl. No.: 14/457,438

(22) Filed: Aug. 12, 2014

(51) Int. Cl. A47J 36/24

(52) U.S. Cl. CPC A47J 36/2466

(57) ABSTRACT

The drinking assembly for dispensing a beverage includes a container that may contain a beverage. A heating element is coupled to the container. The heating element may heat the beverage. An actuator is coupled to the housing. The actuator is operationally coupled to the heating element. The actuator actuates the heating element.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### A. Field of the Invention

The present invention relates to the field of portable beverage containers.

### SUMMARY OF THE INVENTION

An embodiment of the disclosure meets the needs presented above by generally comprising a container that may contain a beverage. A heating element is coupled to the container. The heating element may heat the beverage. An actuator is coupled to the housing. The actuator is operationally coupled to the heating element. The actuator actuates the heating element.

These together with additional objects, features and advantages of the portable beverage container will be readily apparent to those of ordinary skill in the art upon reading the following detailed description of presently preferred, but nonetheless illustrative, embodiments of the portable beverage drawings.

In this respect, before explaining the current embodiments of the portable beverage container in detail, it is to be understood that the portable beverage container is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the portable beverage container.

It is therefore important that the claims be regarded as including such equivalent construction insofar as they do not depart from the spirit and scope of the portable beverage container. It is also to be understood that the phraseology and terminology employed herein are for purposes of description and should not be regarded as limiting.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a drinking assembly according to an embodiment of the disclosure.

FIG. 2 is a front perspective view of an embodiment of the disclosure.

FIG. 3 is a right side view of an embodiment of the disclosure.

FIG. 4 is a front view of an embodiment of the disclosure.

FIG. 5 is a top view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

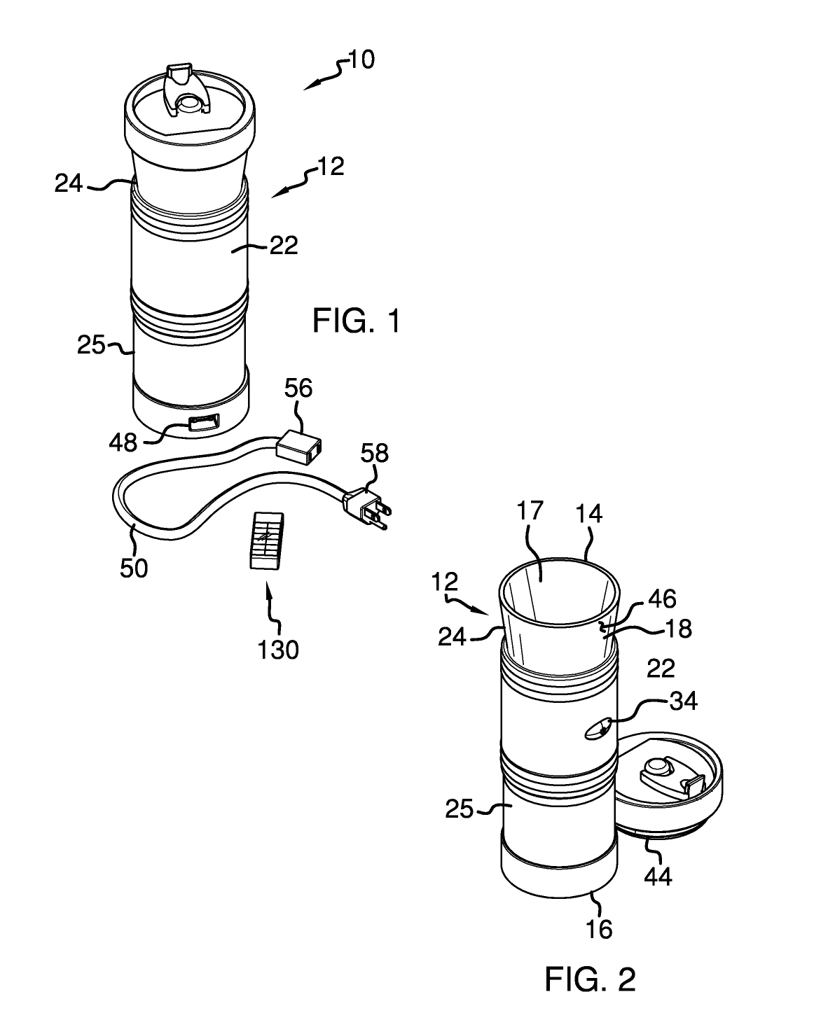

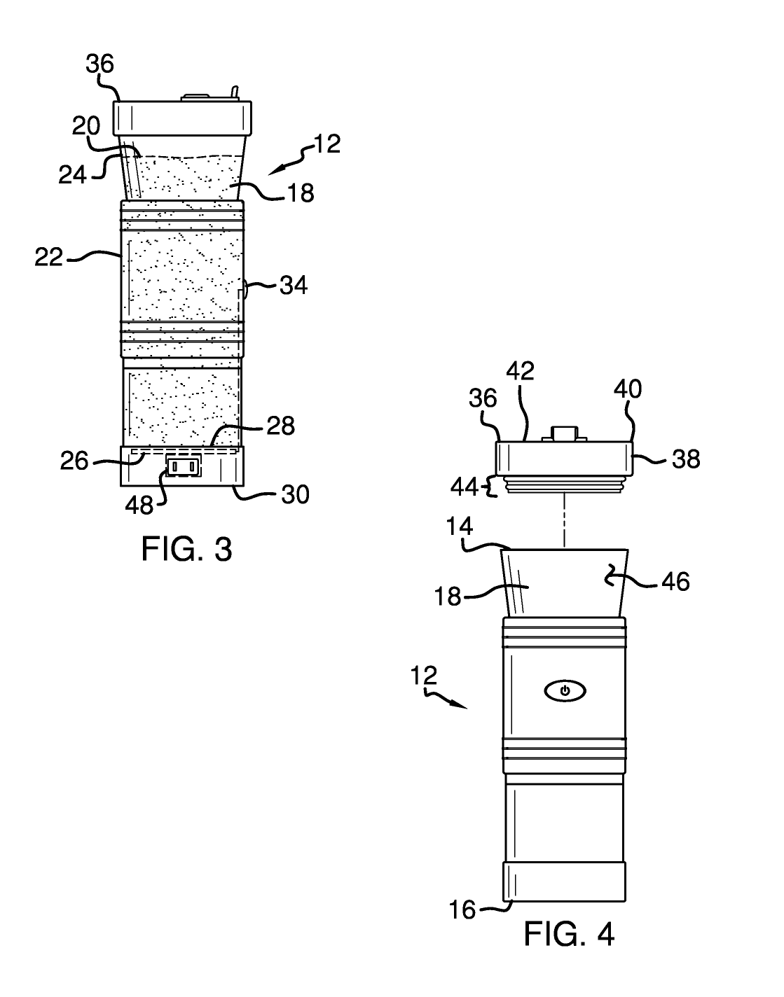

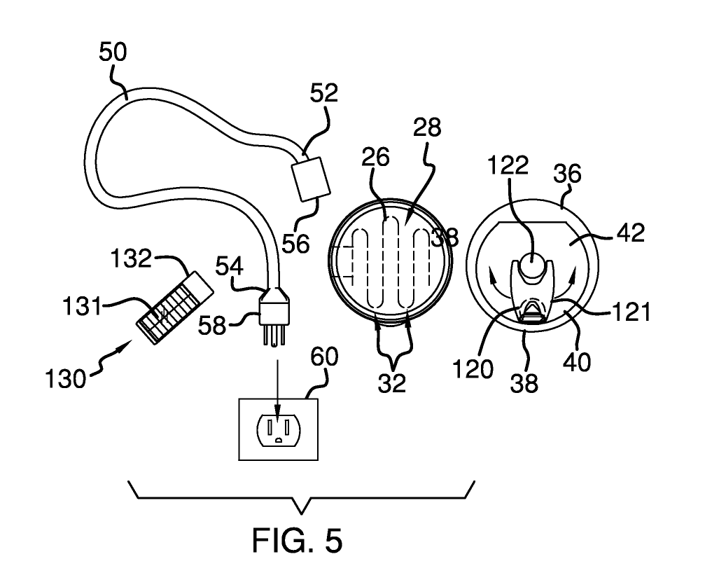

As best illustrated in FIGS. 1 through 5, the drinking assembly 10 generally comprises a container 12 that has a top end 14 and a bottom end 16. The top end 14 of the container 12 is open. The container 12 is elongated between the top 14 and bottom 16 ends. An outer wall 18 of the container 12 is curvilinear. The container 12 has a cylindrical shape. The container 12 may contain a beverage 20. A central portion 22 of the outer wall 18 of the container 12 has a diameter that is greater than a diameter of each of a top portion 24 and a bottom portion 25 of the outer wall 18 of the container 12.

A heating element 26 is coupled to the container 12. The heating element 26 is positioned between a top surface 28 and a bottom surface 30 of the bottom end 16 of the container 12. The heating element 26 may heat the beverage 20 so the beverage 20 may be brewed. The brewed beverage 20 may be tea or other similar brewed beverage. The heating element 26 comprises a plurality of coils 32. The plurality of coils 32 is evenly distributed along an entire diameter of the bottom end 16 of the container 12. The heating element 26 may have an operational temperature between 120° Fahrenheit and 150° Fahrenheit.

An actuator 34 is coupled to the outer wall 18 of the container 12. The actuator 34 is centrally positioned on the outer wall 18 of the container 12. Additionally, the actuator 34 is electrically coupled to the heating element 26. The actuator 34 is actuatable to an “on” position so the actuator 34 actuates the heating element 26. The actuator 34 is actuatable to an off position so the actuator 34 de-actuates the heating element 26.

A lid 36 has an exterior wall 38 extending downwardly from an outer edge 40 of a top wall 42 of the lid 36. The outer edge 40 of the top wall 42 of the lid is curved. The lid 36 has a cylindrical shape. A series of concaving ribs 44 extends downwardly from the exterior wall 38. The series of concaving ribs 44 engages against an inner surface 17 of the container 12. The container 12 is further defined with an outer surface 46 of the outer wall 18 of the container 12. The outer surface 46 of the container 12 as well as a portion of the inner surface 17 of the container 12 is concave so as to correspond to the series of concaving ribs 44 of the lid 36. The lid 36 closes the top end 14 of the container 12. The lid 36 also includes a sipping hole 120, and closure member 121. The closure member 121 rotates with respect to a closure pivot point 122 in order to expose or seal off the sipping hole 120.

A power port 48 is coupled to the outer wall 18 of the container 12. The power port 48 is positioned proximate the bottom end 16 of the container 12. Moreover, the power port 48 is recessed into the outer wall 18 of container 12. The power port 48 is electrically coupled to the heating element 26. It shall be noted that a rechargeable battery may be included in-line, and between both the heating element 26 as well as the power port 48. A rechargeable battery is well known in the art, and is optionally employed.

A power cord 50 is provided. The power cord 50 has a first end 52 and a second end 54. A charge plug 56 is electrically coupled to the first end 52 of the power cord 50. A power plug 58 is electrically coupled to the second end 54 of the power cord 50.

The charge plug 56 is removably coupled to the power port 48 so the power cord 50 is electrically coupled to the power port 48. The power plug 58 is electrically coupled to a power source 60. The power source 60 may be an electrical outlet 62 of any conventional design. The drinking assembly 10 may include a solar charger 130. The solar charger 130 includes at least one solar cell 131, and a solar plug 132 that is able to be plugged into the power port 48 in order to provide electricity in lieu of the power cord 50.

In use, the beverage 20 is poured into the container 12. If the beverage 20 is to be brewed inside of the container 12, the beverage 20 and all components associated therewith are inserted into the container 12, and then the power cord 50 is electrically coupled between the power port 48 and the power source 60. The actuator 34 is actuated to the “on” position to heat the beverage 20, which may simultaneously “brew” the beverage 20. Additionally, the heating element 26 is used to maintain a hot beverage 20 at a heated temperature.

With respect to the above description, it is to be realized that the optimum dimensional relationship for the various components of the drinking assembly 10, to include variations in size, materials, shape, form, function, and the manner of operation, assembly and use, are deemed readily apparent and obvious to one skilled in the art, and all equivalent relationships to those illustrated in the drawings and described in the specification are intended to be encompassed by the drinking assembly 10.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A drinking assembly for dispensing a heated beverage, said assembly comprising:
a container configured to contain the beverage;
a heating element coupled to said container such that said heating element is configured to heat the beverage;
an actuator coupled to said housing, said actuator being operationally coupled to said heating element such that said actuator actuates said heating element.

2. The assembly according to claim 1 wherein said container having a top end and a bottom end, said top end of said container being open.

3. The assembly according to claim 2 wherein said container being elongated between said top and bottom ends; wherein said outer wall of said container being curvilinear such that said container has a cylindrical shape.

4. The assembly according to claim 3 wherein said heating element being positioned between a top surface and a bottom surface of a bottom end of said container; wherein said heating element comprising a plurality of coils being evenly distributed along an entire diameter of a bottom end of said container.

5. The assembly according to claim 4 wherein said actuator being coupled to an outer wall of said container.

6. The assembly according to claim 5 wherein said actuator being centrally positioned on an outer wall of said container; wherein said actuator being electrically coupled to said heating element.

7. The assembly according to claim 6 wherein a lid having an exterior wall extending downwardly from an outer edge of a top wall of said lid; wherein said outer edge of said top wall of said lid being curved such that said lid has a cylindrical shape.

8. The assembly according to claim 7 wherein said lid includes a series of concaving ribs extends downwardly from the exterior wall; wherein the series of concaving ribs engages against an inner surface of the container.

9. The assembly according to claim 8 wherein the container is further defined with an outer surface of the outer wall of the container; wherein the outer surface of the container as well as a corresponding portion of the inner surface of the container is concave so as to correspond to the series of concaving ribs of the lid thereby forming a snug fit between the lid and the container; wherein the lid closes the top end of the container.

10. The assembly according to claim 9 wherein the lid includes a sipping hole, and closure member; wherein the closure member rotates with respect to a closure pivot point in order to expose or seal off the sipping hole.

11. The assembly according to claim 10 wherein a power port is coupled to the outer wall of the container; wherein the power port is positioned proximate the bottom end of the container; wherein the power port is recessed into the outer wall of container; wherein the power port is electrically coupled to the heating element.

12. The assembly according to claim 11 wherein a power cord is provided; wherein the power cord has a first end and a second end; wherein a charge plug is electrically coupled to the first end of the power cord; wherein a power plug is electrically coupled to the second end of the power cord.

13. The assembly according to claim 12 wherein the charge plug is removably coupled to the power port so the power cord is electrically coupled to the power port; wherein the power plug is electrically coupled to a power source; wherein the power source is an electrical outlet.

14. The assembly according to claim 13 wherein a solar charger is included, and is used in lieu of the power cord; wherein the solar charger includes at least one solar cell thereon, and a solar plug that is able to be plugged into the power port in order to provide electricity.

15. A drinking assembly for dispensing a heated beverage, said assembly comprising:
a container configured to contain the beverage;
a heating element coupled to said container such that said heating element is configured to heat the beverage;
an actuator coupled to said housing, said actuator being operationally coupled to said heating element such that said actuator actuates said heating element;
wherein said container having a top end and a bottom end, said top end of said container being open;
wherein said container being elongated between said top and bottom ends; wherein said outer wall of said container being curvilinear such that said container has a cylindrical shape;
wherein said heating element being positioned between a top surface and a bottom surface of a bottom end of said container; wherein said heating element comprising a plurality of coils being evenly distributed along an entire diameter of a bottom end of said container;
wherein said actuator being coupled to an outer wall of said container.

16. The assembly according to claim 15 wherein said actuator being centrally positioned on an outer wall of said container; wherein said actuator being electrically coupled to said heating element; wherein a lid having an exterior wall extending downwardly from an outer edge of a top wall of said lid; wherein said outer edge of said top wall of said lid being curved such that said lid has a cylindrical shape; wherein said lid includes a series of concaving ribs extends downwardly from the exterior wall; wherein the series of concaving ribs engages against an inner surface of the container.

17. The assembly according to claim 16 wherein the container is further defined with an outer surface of the outer wall of the container; wherein the outer surface of the container as well as a corresponding portion of the inner surface of the container is concave so as to correspond to the series of concaving ribs of the lid thereby forming a snug fit between the lid and the container; wherein the lid closes the top end of the container; wherein the lid includes a sipping hole, and closure member; wherein the closure member rotates with respect to a closure pivot point in order to expose or seal off the sipping hole.

18. The assembly according to claim 17 wherein a power port is coupled to the outer wall of the container; wherein the power port is positioned proximate the bottom end of the container; wherein the power port is recessed into the outer wall of container; wherein the power port is electrically coupled to the heating element; wherein a power cord is provided; wherein the power cord has a first end and a second end; wherein a charge plug is electrically coupled to the first end of the power cord; wherein a power plug is electrically coupled to the second end of the power cord; wherein the charge plug is removably coupled to the power port so the power cord is electrically coupled to the power port; wherein the power plug is electrically coupled to a power source; wherein the power source is an electrical outlet.

19. The assembly according to claim 18 wherein a solar charger is included, and is used in lieu of the power cord; wherein the solar charger includes at least one solar cell thereon, and a solar plug that is plugged into the power port in order to provide electricity.
